(19) United States
(12) Patent Application Publication
(10) Pub. No.: US 2007/0131012 A1
(43) Pub. Date: Jun. 14, 2007

(54) Hybrid component and associated production method

(75) Inventors: Konrad Eipper, Rottenburg (DE); Bernd Klepsch, Bremen (DE); Juergen Knothe, Gaertringen (DE); Bernhard Spies, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuggart (DE)

(21) Appl. No.: 10/567,255

(22) PCT Filed: Aug. 5, 2004
(86) PCT No.: PCT/EP04/08777

§ 371 Date: Jul. 6, 2006

(30) Foreign Application Priority Data
Aug. 7, 2003 (DE) 10336187.1

(51) Int. Cl. B32B 3/24; B29C 45/14; B21C 23/24

(52) U.S. Cl. 72/46; 428/137; 264/279; 264/279.1

(57) ABSTRACT

The present invention relates to a hybrid component comprising a sheet-metal metal body and a plastic body injection-molded onto the sheet-metal body. The sheet-metal body is produced by cutting, edging, stamping and/or plastic forming a plate-shaped metal sheet, and has a surface coating on at least one visible side, as well as at least one uncoated cut or stamped edge. The plastic body is injection-molded so that it seals the at least one uncoated or stamped edge of the sheet metal body and stiffens the sheet metal body.

### BACKGROUND AND SUMMARY OF THE INVENTION

This application claims the priority of German patent document 103 36 187.1, filed Aug. 7, 2003 (PCT International Application No. PCT/EP2004/008777, filed Aug. 5, 2004), the disclosure of which is expressly incorporated by reference herein.

The present invention relates to a hybrid component comprising a metal body and a plastic body that is injection molded onto the metal body, and to an associated production method.

A hybrid component of this type is known, for example, from DE 100 29 411 A1 and consists of a metal body and of a plastic body injected-molded on the latter. In the known hybrid component, the plastic body serves to connect two metal bodies, the plastic body being injection-molded such that it forms an electrically insulating layer between, in this case, an extruded profile and a sandwich element.

In order to protect the metallic surfaces of a hybrid component from environmental influences, in particular from corrosion, it is possible, in principle, to provide the respective metal body with a suitable surface coating. This, however, may be relatively complicated.

For metal bodies which are produced from a coil-coated metal sheet, there is, according to DE 37 04 364 C1, the possibility of coating and sealing cut edges formed during edging and stamping operations using UV radiation cured lacquers.

Also, it is known from DE 40 11 320 C2 to seal cut edges of stamped, pressed, or cut plate-shaped metal parts by coating with a coating powder by means of an electrostatic powder spraying method.

However, the known methods for sealing cut edges of this type are comparatively complicated.

One object of the present invention is to provide a cost-effective method of producing a hybrid component with surface protection.

This and other objects and advantages are achieved by the present invention, which is based on the general idea of using a surface-coated sheet metal body for producing the hybrid component, and modifying the injection molding of the plastic body in a controlled way, such that the plastic body is molded around cut edges formed during the production of the sheet metal body from a plate-shaped metal sheet. As a result, the sealing of the cut edges is integrated into the injection molding of the plastic body.

Furthermore, in order to increase the stability of the sheet metal body, the plastic body is at the same time designed to stiffen the metal body, so that the plastic body has a double function. Overall, the hybrid component can thus have the desired rigidity due to the stiffening of the sheet metal body by the plastic body. Moreover, by refining the injection molding operation, the hybrid component can be produced cost-effectively, with its metal surfaces protected from harmful environmental conditions.

In an advantageous embodiment of the invention development, in the region of the uncoated edges of the sheet metal body, the plastic body may consist of a plastic other than that in the remaining body. By virtue of this type of construction, the plastics can be optimized in terms of their functions. For example, the plastic injection-molded onto the edges can be selected in light of the surface protection desired for the sheet metal body, while the plastic in the remaining plastic body can be selected in light of the desired stiffening effect.

Other objects, advantages and novel features of the present invention will become apparent from the following detailed description of the invention when considered in conjunction with the accompanying drawings.

### BRIEF DESCRIPTION OF THE DRAWINGS

FIGS. 1 to 4 are simplified basic illustrations which show a longitudinal section through a hybrid component according to the invention, in various phases of its production; and

FIGS. 5 and 6 show other embodiments as in FIG. 4.

### DETAILED DESCRIPTION OF THE DRAWINGS

Preferred exemplary embodiments of the invention are illustrated in the drawings and are explained in more detail in the following description, wherein the same reference symbols relate to identical or functionally identical or similar components.

As shown in FIG. 4, a hybrid component 1 according to the invention comprises a metallic sheet metal body 2 and a plastic body 3 which, as shown, may be a multipart. The sheet metal body 2 is provided with a surface coating 4 on at least one visible side (here on both visible sides). By virtue of its production and/or processing, the sheet metal body 2 has uncoated edges 5 which arise during the edging of the sheet metal body 2 on its outsides and/or during the punching out of, in particular, a perforation 6. Such edges may also be the result of another processing method.

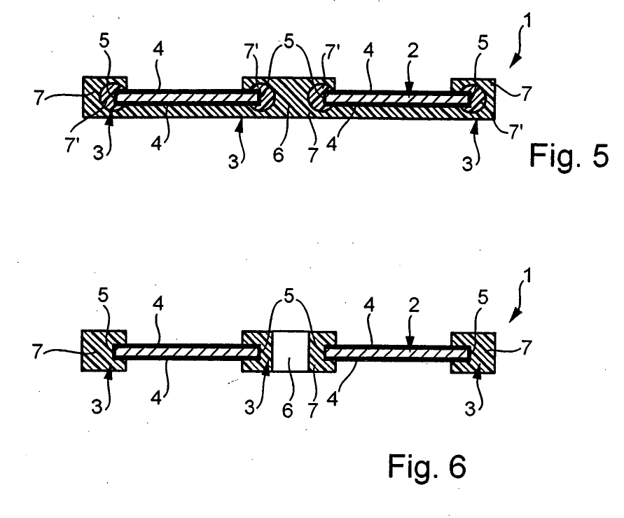

According to the invention, the plastic body 3 is injected-molded onto the sheet metal body 2 such that the uncoated edges 5 are thereby sealed. That is, the free edges 5 are framed by the plastic 7 of the plastic body 3.

Whereas, in the embodiment according to FIG. 4, the plastic body 3 is produced in a unitary manner from one and the same plastic 7, FIG. 5 shows a variant in which the plastic body 2 is designed as a two-component part, specifically such that, it consists, in the region of the edges 5, of a plastic 7′ other than that in the remaining plastic body 3. As a result, within the plastic body 3, either plastic (7 or 7′) can be optimized according to its function. For example, the plastic 7′ formed over the edges 5 is suitable especially for surface protection of the sheet metal body 2, while the plastic 7 used in the remaining plastic body 3 is selected based on the main function of the plastic body 3. In the hybrid component 1 according to the invention, this main function is the stiffening of the sheet metal body 2. This means that the hybrid component 1 can acquires its desired rigidity and strength due to the bond between sheet metal body 2 and plastic body 3.

The hybrid component 1 may be used, for example, in motor vehicle construction, such as for trim element which is foam-backed and stiffened with the aid of the plastic body 3.

In the embodiment shown in FIG. 5, the plastic body 3 is configured such that it completely covers one of the visible sides of the sheet metal body 2.

The embodiment according to FIG. 6 corresponds essentially to the variant from FIG. 4, but shows that the plastic body 3 does not have to fill the perforation 6 completely. The injection-molded plastic 7 surrounds or seals the edge 5 of the perforation 6 so that, even after the injection molding of the plastic body 3, an orifice passing through the hybrid component 1 remains.

A method according to the invention for the production of the hybrid component 1 (according to the variant shown in FIG. 4) is explained in more detail below.

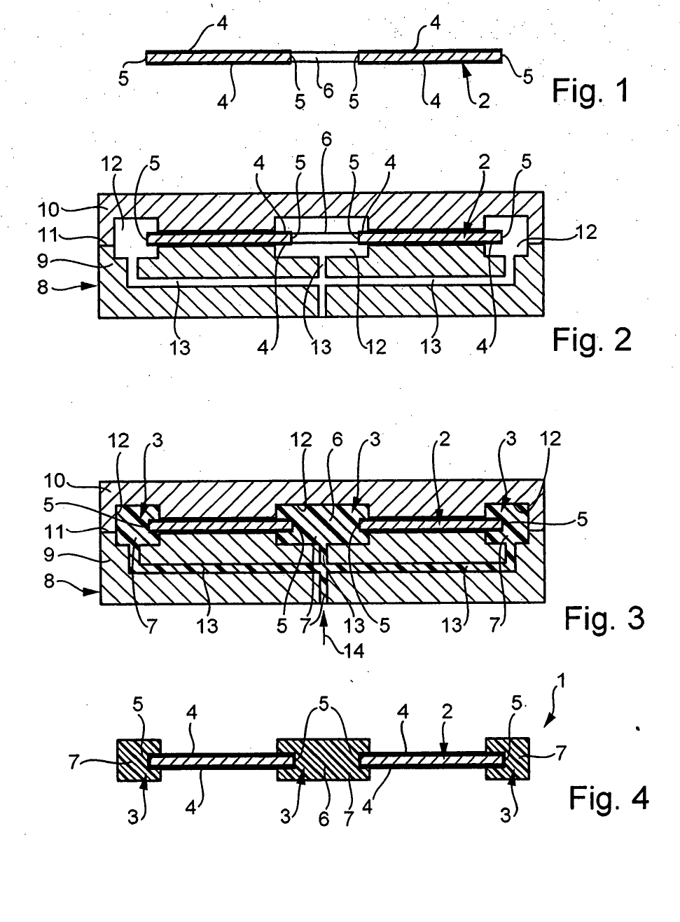

First, according to FIG. 1, the sheet metal body 2 is produced from a plate-shaped metal sheet, in particular from a coil-coated metal sheet, which is provided at least on one visible side with the surface coating 4. In this case, the shape desired for the sheet metal body 2 is produced from the plate-shaped metal sheet by plastic forming, edging, cutting and/or stamping, thereby forming the uncoated cut or stamped edges 5.

According to FIG. 2, the sheet metal body 2 produced in this way is introduced into an injection-molding die 8 which has a lower part 9 and an upper part 10 that come to bear one against the other at a parting line 11. To produce the plastic body 3 or its parts, cavities 12 are formed in the injection-molding die 8 and are connected to injection ducts 13. Corresponding venting ducts (not shown) may also be provided.

According to FIG. 3, the plastic 7 is injected in the direction of arrow 14 into the cavities 12 through the injection ducts 13, with the result that the plastic body 3 is formed in the cavities 12. The cavities 12 are configured such that the injected plastic 7 can close and thereby seal the edges 5 of the sheet metal body 2.

According to FIG. 4, after being removed from the injection-molding die 8, the hybrid component 1 is essentially finished.

In so far as the plastic body 3 is designed as a two-component part, the plastic 7′ sealing the edges 5 can be injection-molded first in a first injection-molding die. Subsequently, in a second injection-molding die, the other plastic 7 can be injection-molded in order to form the remaining plastic body 3. A variant is preferred, however, in which the two-component technology can be carried out in one and the same injection-molding die 8.

All of the above-mentioned references are herein incorporated by reference in their entirety to the same extent as if each individual reference was specifically and individually indicated to be incorporated herein by reference in its entirety.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A hybrid component comprising a metal body and a plastic body injection-molded onto the metal body, wherein:
the metal body is a sheet metal body formed by one of edging, stamping, plastic forming and cutting a plate-shaped metal sheet provided with a surface coating on at least one visible side thereof;
the metal body has at least one uncoated edge, and
the plastic body is adapted to stiffen the sheet metal body and seal the at least one uncoated edge.

2. The hybrid component as claimed in claim 1, wherein the sheet metal body is produced from a coil—of coated metal sheet.

3. The hybrid component as claimed in claim 1, wherein, in a region of the uncoated edges of the sheet metal body, the plastic body comprises a plastic other than that in the remaining body.

4. The hybrid component as claimed in claim 3, wherein the plastic body is one of a single-component part and a two-component part.

5. The hybrid component as claimed in claim 1 wherein the plastic body completely covers a visible side of the sheet metal body.

6. A method for the production of a hybrid component comprising a sheet metal body and a plastic body, the method comprising:
forming a sheet metal body by one of edging, stamping, plastic forming and cutting a plate-shaped metal sheet provided with a surface coating on at least one visible side, whereby at least one uncoated cut edges is formed on the sheet metal body,
injection molding a plastic body onto the sheet metal body such that the plastic body stiffens the sheet metal body and seals the at least one uncoated edges.

7. The method as claimed in claim 6, wherein the sheet metal body is produced from a coil—of coated metal sheet.

8. The method as claimed in claim 6, wherein:
the plastic body is injection-molded onto the sheet metal body by means of a two-component technology; and
in a region of uncoated edges of the sheet metal body, the plastic body comprises a plastic which differs from that in the remaining body.

9. The method as claimed in claim 8, wherein the injection molding of the plastic body by the two-component technology is carried out in a single injection-molding die.

10. The method as claimed in claim 6, wherein the plastic body is injection-molded onto the sheet metal body such that it completely covers a visible side of the sheet metal body.

11. A hybrid component comprising:
a sheet metal body formed from a plate-shaped metal sheet using a forming process selected from the group consisting of edging, stamping, plastic forming and cutting;
a surface coating formed on at least one visible side of said sheet metal body, said surface coating covering said at least one visible side, except for at least one uncoated edge formed during said forming process; and
a plastic body injection-molded onto the sheet metal body;
wherein the plastic body is adapted to stiffen the sheet metal body and seals the at least one uncoated edge.

12. A method of making a hybrid component comprising a sheet metal body and a plastic body, the method comprising:
providing a plate-shaped metal sheet having a surface coating on at least one visible side thereof;
forming a sheet metal body having at least one uncoated cut or stamped edge by one of edging, stamping, plastic forming and cutting the plate-shaped metal sheet; and
forming a plastic body by injection molding a plastic material onto the sheet metal body;
wherein the plastic body is adapted to stiffen the sheet metal body, and seals the at least one uncoated cut or stamped edge.
